(19) United States
(12) Patent Application Publication
(10) Pub. No.: US 2008/0066783 A1
(43) Pub. Date: Mar. 20, 2008

(54) SUBSTRATE TREATMENT APPARATUS AND SUBSTRATE TREATMENT METHOD

(76) Inventor: Masato Tanaka, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/857,686

(22) Filed: Sep. 19, 2007

(30) Foreign Application Priority Data
Sep. 20, 2006 (JP) 2006-254913

(51) Int. Cl. B08B 5/04

(52) U.S. Cl. 134/21; 134/95.2

(57) ABSTRACT

A substrate treatment apparatus according to the present invention includes: a plate to be positioned in spaced opposed relation to one surface of a substrate and having a plurality of outlet ports and a plurality of suction ports provided in an opposed surface thereof to be opposed to the one surface of the substrate; a rinse liquid supplying unit which supplies a rinse liquid containing deionized water to the outlet ports of the plate; a suction unit which evacuates the suction ports of the plate; a drying promoting fluid supplying unit which supplies a drying promoting fluid to the one surface of the substrate to promote drying of the substrate; a substrate holding unit to be positioned on the other surface of the substrate opposite from the one surface for holding the substrate; and a supply controlling unit which controls the rinse liquid supplying unit to discharge the rinse liquid from the outlet ports toward the one surface of the substrate to seal a space defined between the one surface and the opposed surface with the rinse liquid, and controls the drying promoting fluid supplying unit to supply the drying promoting fluid to the one surface with the space between the one surface and the opposed surface kept in a liquid sealed state to replace the rinse liquid present between the one surface and the opposed surface with the drying promoting fluid.

### BACKGROUND OF THE INVENTION

1. Field of the Invention

The present invention relates to a substrate treatment apparatus and a substrate treatment method which are adapted to dry a substrate rinsed with a rinse liquid containing deionized water. Examples of the substrate to be treated include semiconductor wafers, substrates for liquid crystal display devices, substrates for plasma display devices, substrates for FED (Field Emission Display) devices, substrates for optical disks, substrates for magnetic disks, substrates for magneto-optical disks, substrates for photo masks, and the like.

2. Description of the Related Art

In production processes for semiconductor devices and liquid crystal display devices, a substrate treatment apparatus of a single substrate treatment type is employed, which is adapted to treat a surface of a single substrate such as a semiconductor wafer or a glass substrate for a liquid crystal display panel with a treatment liquid (a chemical agent, deionized water or other rinse liquid).

The substrate treatment apparatus of this type includes a spin chuck which generally horizontally holds a single substrate and rotates the substrate, a nozzle for supplying the treatment liquid to a surface (upper surface) of the substrate held by the spin chuck, and a disk-shaped shield plate to be positioned in closely opposed relation to the surface of the substrate held by the spin chuck (for example, Japanese Unexamined Patent Publication (KOKAI) No. 10-41261).

The substrate treatment apparatus having such a construction performs a chemical agent treatment process and a water rinsing process, for example, by sequentially supplying a chemical agent and deionized water onto the surface of the rotating substrate. After the water rinsing process, a space defined between the surface of the substrate and the shield plate is isolated from an ambient environment by the shield plate positioned in closely opposed relation to the surface of the substrate. In this state, IPA (isopropylalcohol) vapor is supplied around a rotation center onto the substrate surface from an outlet port provided at the center of the shield plate. The IPA vapor supplied around the rotation center on the substrate surface spreads over the substrate surface from the rotation center toward a peripheral edge of the substrate. Thus, deionized water adhering to the substrate surface is spun off around the substrate by the rotation of the substrate. Deionized water still remaining on the substrate surface is replaced with the IPA. The substrate surface is dried by evaporation of the IPA.

In the aforementioned treatment method, however, an oxygen-containing atmosphere is present between the substrate surface and the shield plate during a period from the water rinsing process to the supply of the IPA vapor to the substrate surface. Oxygen in this atmosphere is liable to react with the deionized water adhering to the substrate surface and silicon contained in the substrate surface to form water marks on the substrate surface.

### SUMMARY OF THE INVENTION

It is an object of the present invention to provide a substrate treatment apparatus and a substrate treatment method which ensure proper drying of a substrate while suppressing formation of water marks.

A substrate treatment apparatus according to the present invention includes: a plate to be positioned in spaced opposed relation to one surface of a substrate and having a plurality of outlet ports and a plurality of suction ports provided in an opposed surface thereof to be opposed to the one surface of the substrate; a rinse liquid supplying unit which supplies a rinse liquid containing deionized water to the outlet ports of the plate; a suction unit which evacuates the suction ports of the plate; a drying promoting fluid supplying unit which supplies a drying promoting fluid to the one surface of the substrate to promote drying of the substrate; a substrate holding unit to be positioned on the other surface of the substrate opposite from the one surface for holding the substrate; and a supply controlling unit which controls the rinse liquid supplying unit to discharge the rinse liquid from the outlet ports toward the one surface of the substrate to seal a space defined between the one surface and the opposed surface with the rinse liquid, and controls the drying promoting fluid supplying unit to supply the drying promoting fluid to the one surface with the space between the one surface and the opposed surface kept in a liquid sealed state to replace the rinse liquid present between the one surface and the opposed surface with the drying promoting fluid.

With this arrangement, the rinse liquid containing the deionized water is discharged from the plurality of outlet ports provided in the opposed surface of the plate onto the one surface of the substrate by the rinse liquid supplying unit with the plate being positioned in closely opposed relation to the one surface and, at the same time, the discharged rinse liquid is sucked from the plurality of suction ports provided in the opposed surface of the plate by the suction unit. Therefore, while the space defined between the one surface and the opposed surface is sealed with the rinse liquid, currents are generated in the rinse liquid present between the one surface and the opposed surface. Thus, the rinse liquid is evenly supplied to the one surface of the substrate.

Further, the supply controlling unit controls the drying promoting fluid supplying unit with the space between the one surface and the opposed surface sealed with the rinse liquid to supply the drying promoting fluid to the one surface of the substrate for promoting the drying of the substrate. Thus, the rinse liquid present between the one surface and the opposed surface is squeezed out by the drying promoting fluid, and replaced with the drying promoting fluid. That is, the rinse liquid present between the one surface and the opposed surface is replaced with the drying promoting fluid without admitting an oxygen-containing atmosphere into the space between the one surface and the opposed surface. Therefore, reactions of oxygen with the deionized water and silicon contained in the substrate surface are suppressed until the one surface is dried. This ensures proper drying of the substrate while suppressing formation of water marks.

The drying promoting fluid to be supplied to the one surface of the substrate from the drying promoting fluid supplying unit may be a liquid, a gas or a fluid mixture of a gas and a liquid.

The drying promoting fluid supplying unit may supply a liquid containing an organic solvent more volatile than the deionized water as the drying promoting fluid to the one surface. The drying promoting fluid supplying unit may supply a vapor containing an organic solvent more volatile than the deionized water as the drying promoting fluid to the one surface.

The liquid or the vapor containing the organic solvent more volatile than the deionized water is supplied to the one surface of the substrate rinsed with the rinse liquid containing the deionized water. Thus, the rinse liquid present between the one surface and the opposed surface is replaced with the liquid containing the drying promoting fluid. This promotes the drying of the substrate.

The organic solvent may be a solvent soluble in the deionized water or insoluble in the deionized water.

Where the organic solvent is more volatile than the deionized water and soluble in the deionized water, the deionized water contained in the rinse liquid is dissolved in the drying promoting fluid, and the rinse liquid is replaced with the drying promoting fluid. Thus, the drying of the substrate is promoted. Where the organic solvent is more volatile than the deionized water and insoluble in the deionized water, the rinse liquid present between the one surface and the opposed surface is readily squeezed out and, therefore, completely replaced with the drying promoting fluid.

Examples of the organic solvent which is more volatile than the deionized water and soluble in the deionized water include methanol, ethanol, acetone, IPA (isopropyl alcohol) and MEK (methyl ethyl ketone). An example of the organic solvent which is more volatile than the deionized water and insoluble in the deionized water is HFE (hydrofluoroether).

Examples of the rinse liquid include functional water such as DIW (deionized water), carbonated water, electrolyzed ion water, hydrogen water and magnetic water, and ammonia water having a very low concentration (e.g., about 1 ppm).

The drying promoting fluid supplying unit may supply the drying promoting fluid to the one surface of the substrate from a drying promoting fluid outlet port which is provided in the opposed surface of the plate to be brought into opposed relation to the center of the one surface.

The drying promoting fluid is supplied to the center of the one surface from the drying promoting fluid outlet port with the space between the one surface and the opposed surface sealed with the rinse liquid. Then, the rinse liquid present between the one surface and the opposed surface is squeezed out around the substrate by the drying promoting fluid spreading from the center of the one surface toward the periphery of the substrate. Thus, the rinse liquid is replaced with the drying promoting fluid without admitting the oxygen-containing atmosphere into the space between the one surface and the opposed surface.

The substrate treatment apparatus preferably includes a substrate rotating unit which rotates the substrate held by the substrate holding unit about an axis intersecting the one surface.

With this arrangement, the rinse liquid and the drying promoting fluid are evenly supplied to the one surface of the substrate by causing the substrate rotating unit to rotate the substrate while supplying the rinse liquid or the drying promoting fluid to the one surface.

Where the substrate is rotated at a predetermined rotation speed after the drying promoting fluid is supplied to the one surface of the substrate, the liquid replaced with the drying promoting fluid is spun off around the substrate by a centrifugal force. Thus, the time required for the drying of the substrate is reduced.

The substrate treatment apparatus preferably includes a plate rotating unit which rotates the plate coaxially with the axis.

With this arrangement, even supply of the rinse liquid and the drying promoting fluid to the one surface of the substrate is achieved by causing the plate rotating unit to rotate the plate while supplying the rinse liquid or the drying promoting fluid to the one surface. Where the substrate and the plate are simultaneously rotated, the rotation direction of the plate may be the same as or opposite to the rotation direction of the substrate. In this case, the plate is preferably rotated relative to the substrate.

A substrate treatment method according to the present invention includes the steps of: supplying a rinse liquid containing deionized water to one surface of a substrate from a plurality of outlet ports provided in an opposed surface of a plate positioned in spaced opposed relation to the one surface, and sucking the rinse liquid discharged from the outlet ports from a plurality of suction ports provided in the opposed surface of the plate to seal a space defined between the one surface and the opposed surface with the rinse liquid; and supplying a drying promoting fluid to the one surface of the substrate with the space between the one surface and the opposed surface sealed with the rinse liquid to replace the rinse liquid present between the one surface and the opposed surface with the drying promoting fluid.

According to this method, the rinse liquid containing the deionized water is supplied to the one surface of the substrate from the plurality of outlet ports provided in the opposed surface of the plate with the plate being positioned in closely opposed relation to the one surface, and the rinse liquid discharged from the outlet ports is sucked from the plurality of suction ports provided in the opposed surface of the plate, whereby the space defined between the one surface and the opposed surface is sealed with the rinse liquid in the rinse liquid supplying step. Therefore, with the space between the one surface and the opposed surface being sealed with the rinse liquid, currents are generated in the rinse liquid present in the space. Thus, the rinse liquid is evenly supplied to the one surface of the substrate.

Then, the drying promoting fluid for promoting drying of the substrate is supplied to the one surface of the substrate with the space between the one surface and the opposed surface sealed with the rinse liquid, whereby the rinse liquid present between the one surface and the opposed surface is replaced with the drying promoting fluid in the drying promoting fluid supplying step. That is, the rinse liquid present between the one surface and the opposed surface is replaced with the drying promoting fluid without admitting an oxygen-containing atmosphere into the space defined between the one surface and the opposed surface. Therefore, reactions of oxygen with the deionized water and silicon contained in the substrate surface are suppressed. This ensures proper drying of the substrate while suppressing formation of water marks.

The foregoing and other objects, features and effects of the present invention will become more apparent from the following detailed description of the preferred embodiments with reference to the attached drawings.

### BRIEF DESCRIPTION OF THE DRAWINGS

FIG. 1 is a schematic diagram for explaining the construction of a substrate treatment apparatus according to one embodiment of the present invention;

FIG. 2 is a bottom view illustrating the opposed surface of a plate;

FIG. 3 is a block diagram for explaining the electrical construction of the substrate treatment apparatus of FIG. 1;

FIGS. 4(a) to 4(e) are diagrams for explaining an exemplary substrate treatment process to be performed by the substrate treatment apparatus of FIG. 1; and

FIG. 5 is a schematic diagram illustrating a part of a substrate treatment apparatus according to another embodiment of the present invention.

### DETAILED DESCRIPTION OF PREFERRED EMBODIMENTS

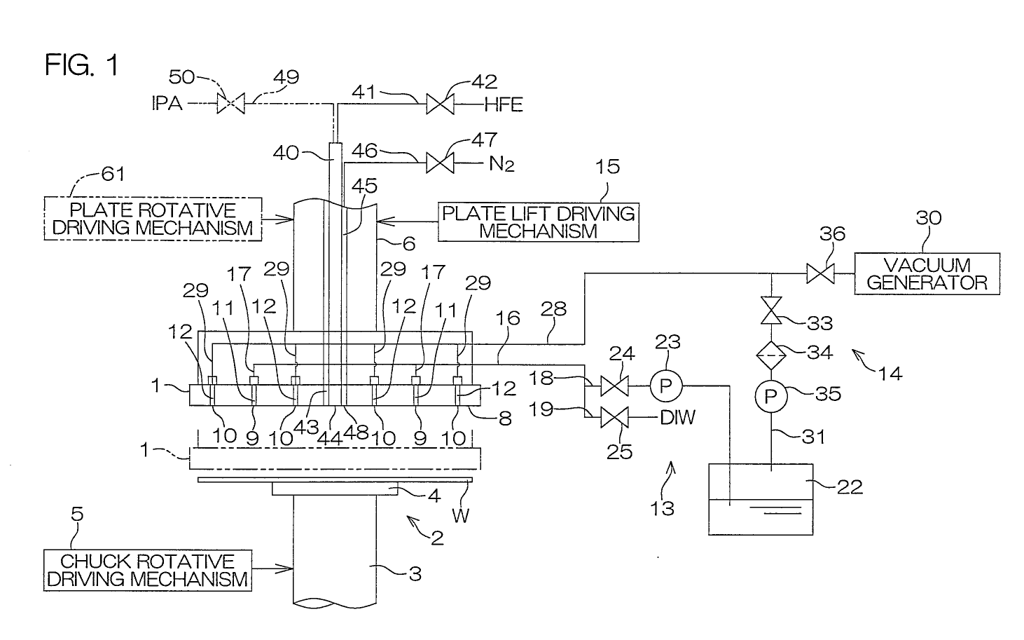

FIG. 1 is a schematic diagram for explaining the construction of a substrate treatment apparatus according to one embodiment of the present invention. The substrate treatment apparatus is of a single substrate treatment type, which is adapted to treat a generally round substrate W such as a semiconductor wafer with a treatment liquid (a chemical agent, deionized water or other rinse liquid). The substrate treatment apparatus includes a plate 1 to be positioned in spaced opposed relation to a front surface (upper surface) of the substrate W, and a vacuum-type spin chuck (hereinafter referred to simply as “vacuum chuck”) 2 to be positioned on a rear surface (lower surface) of the substrate W to hold the substrate W generally horizontally and rotate the substrate W.

The vacuum chuck 2 includes a chuck shaft 3 disposed generally vertically, and a disk-shaped suction base 4 generally horizontally fixed to an upper end of the chuck shaft 3. The chuck shaft 3 has, for example, a tubular shape, and includes a suction path provided therein. An upper end of the suction path of the chuck shaft 3 communicates with a suction port provided in an upper surface of the suction base 4 through a suction path provided in the suction base 4. A turning force is inputted to the chuck shaft 3 from a chuck rotative driving mechanism 5 which includes a motor and the like.

Thus, the vacuum chuck 2 sucks the rear surface of the substrate W by vacuum by evacuating the suction path, whereby the substrate W is held on the suction base 4 with the front surface thereof up. In this state, the turning force is inputted to the chuck shaft 3 from the chuck rotative driving mechanism 5, whereby the substrate W held on the suction base 4 by suction is rotated about an axis extending generally through the center of the front surface thereof (the center axis of the chuck shaft 3).

The plate 1 has a disk shape having a greater diameter than the substrate W. A lower surface of the plate 1 is defined as an opposed surface 8 which is brought into opposed relation to the front surface of the substrate W held by the vacuum chuck 2. The opposed surface 8 has a plurality of outlet ports 9 and a plurality of suction ports 10. The outlet ports 9 respectively communicate with generally cylindrical supply paths 11 each extending through the plate 1 along the thickness of the plate 1 (vertically). The suction ports 10 respectively communicate with generally cylindrical suction paths 12 each extending through the plate 1 along the thickness of the plate 1 (vertically). A supply mechanism 13 which selectively supply hydrofluoric acid as the chemical agent and DIW (deionized water) as the rinse liquid is connected to the outlet ports 9. A suction mechanism 14 which sucks the hydrofluoric acid or the DIW discharged from the outlet ports 9 is connected to the suction ports 10.

The supply mechanism 13 is constructed such as to selectively supply the hydrofluoric acid and the DIW to the outlet ports 9 through the supply paths 11. The supply mechanism 13 includes a central supply pipe 16, and a plurality of supply pipe branches 17 branched from the central supply pipe 16 and respectively connected to the supply paths 11. A chemical agent supply pipe 18 and a DIW supply pipe 19 are connected to the central supply pipe 16. The hydrofluoric acid and the DIW are supplied to the central supply pipe 16 from the chemical agent supply pipe 18 and the DIW supply pipe 19, respectively.

The chemical agent supply pipe 18 extends from a chemical agent tank 22 in which the hydrofluoric acid is contained. A chemical agent pump 23 for pumping up the hydrofluoric acid from the chemical agent tank 22 and a chemical agent valve 24 which opens and closes the chemical agent supply pipe 18 are provided in the chemical agent supply pipe 18. The DIW is supplied to the DIW supply pipe 19 from a DIW supply source not shown. A DIW valve 25 which opens and closes the DIW supply pipe 18 is provided in the DIW supply pipe 19.

The hydrofluoric acid contained in the chemical agent tank 22 is supplied to the respective outlet ports 9 by driving the chemical agent pump 23 with the DIW valve 25 being closed and with the chemical agent valve 24 being open. Further, the DIW is supplied to the respective outlet ports 9 from the DIW supply source with the chemical agent valve 24 being closed and with the DIW valve 25 being open.

The suction mechanism 14 includes a central suction pipe 28, and a plurality of suction pipe branches 29 branched from the central suction pipe 28 and respectively connected to the suction paths 12. The central suction pipe 28 is connected to a vacuum generator 30 which evacuates the central suction pipe 28 and to a chemical agent recovery pipe 31 through which the sucked chemical agent (hydrofluoric acid) flows. One end of the chemical agent recovery pipe 31 (a downstream end of the chemical agent recovery pipe 31 with respect to a fluid flowing direction) is connected to the chemical agent tank 22. A recovery valve 33 which opens and closes the chemical agent recovery pipe 31, a filter 34 for removing foreign matter from the hydrofluoric acid flowing through the chemical agent recovery pipe 31 and a recovery pump 35 for drawing the hydrofluoric aid into the chemical agent recovery pipe 31 are provided in the chemical agent recovery pipe 31 in this order from the side of the central suction pipe 28. A suction valve 36 which opens and closes the central suction pipe 28 is provided in the central suction pipe 28 between the vacuum generator 30 and a junction with the chemical agent recovery pipe 31.

The hydrofluoric acid or the DIW discharged from the respective outlet ports 9 is sucked into the vacuum generator 30 through the suction ports 10, the suction paths 12, the suction pipe branches 29 and the central suction pipe 28 by driving the vacuum generator 30 with the recovery valve 33 being closed, with the suction valve 36 being open and with the hydrofluoric acid or the DIW being discharged from the respective outlet ports 9. Further, the hydrofluoric acid discharged from the respective outlet ports 9 is recovered into the chemical agent tank 22 through the suction ports 10, the suction paths 12, the suction pipe branches 29, the central suction pipe 28 and the chemical agent recovery pipe 31 by driving the recovery pump 35 with the suction valve 36 being closed, with the recovery valve 33 being open and with the hydrofluoric acid being discharged from the respective outlet ports 9.

The plate 1 is fixed to a lower end of a support shaft 6 extending along a center axis thereof which is concentric with the chuck shaft 3 of the vacuum chuck 2. The support shaft 6 is a hollow shaft, in which a center axis nozzle 40 for supplying HFE (liquid hydrofluoether) as the drying promoting fluid to the front surface of the substrate W for promoting the drying of the substrate W is inserted without contact with the support shaft 6. An HFE supply pipe 41 for supplying the HFE to the center axis nozzle 40 is connected to the center axis nozzle 40. An HFE valve 42 which opens and closes the HFE supply pipe 41 is provided in the HFE supply pipe 41. A distal end portion (lower end portion) of the center axis nozzle 40 reaches an opening 43 provided at the center of the plate 1. The center axis nozzle 40 has an HFE outlet port 44 provided at the distal end thereof to be opposed to a center potion of the front surface of the substrate W. The HFE supplied to the center axis nozzle 40 is discharged from the HFE outlet port 44 toward the front surface of the substrate W.

A nitrogen gas supply path 45 through which nitrogen gas to be supplied as an inert gas to the front surface of the substrate W flows is defined between the support shaft 6 and the center axis nozzle 40. The nitrogen gas is supplied to the nitrogen gas supply path 45 from a nitrogen gas supply pipe 46. A nitrogen gas valve 47 which opens and closes the nitrogen gas supply pipe 46 is provided in the nitrogen gas supply pipe 46. The nitrogen gas flowing through the nitrogen gas supply path 45 is discharged toward the front surface of the substrate W from a nitrogen gas outlet port 48 defined between the distal end of the center axis nozzle 40 and an inner peripheral surface of the plate 1 defining the opening 43.

The support shaft 6 is connected to a plate lift driving mechanism 15 which moves up and down the support shaft 6 and the plate 1. The plate lift driving mechanism 15 moves the support shaft 6 and the plate 1 up and down between a proximate position at which the opposed surface 8 is located in proximity to the front surface of the substrate W held by the vacuum chuck 2 (as indicated by a two-dot-and-dash line in FIG. 1) and a retracted position at which the opposed surface 8 is substantially spaced upward from the front surface of the substrate W (as indicated by a solid line in FIG. 1). The front surface of the substrate W is kept in a nitrogen gas atmosphere by introducing the nitrogen gas from the nitrogen gas outlet port 48 into a narrow space defined between the front surface of the substrate W and the opposed surface 8 of the plate 1 with the opposed surface 8 kept in proximity to the front surface of the substrate W.

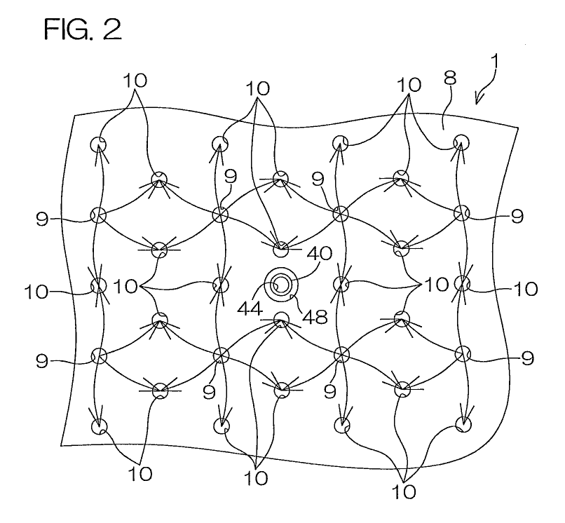

FIG. 2 is a bottom view illustrating the opposed surface 8 of the plate 1. The outlet ports 9 are regularly arranged on the opposed surface 8. The outlet ports 9 are equidistantly arranged in a predetermined direction and a direction orthogonal to the predetermined direction on the opposed surface 8 in a matrix array. The suction ports 10 are regularly arranged around the outlet ports 9. For example, the suction ports 10 are arranged such that six suction ports 10 are located at vertices of a regular hexagon centering on each outlet port 9.

The hydrofluoric acid and the DIW discharged from each outlet port 9 are generally evenly distributed to the six suction ports 10 located around that outlet port 9 as indicated by arrows in FIG. 2.

The HFE outlet port 44 provided at the distal end of the center axis nozzle 40 is surrounded by the annular nitrogen gas outlet port 48. The HFE outlet port 44 and the nitrogen gas outlet port 48 are surrounded by the plurality of outlet ports 9 and the plurality of suction ports 10.

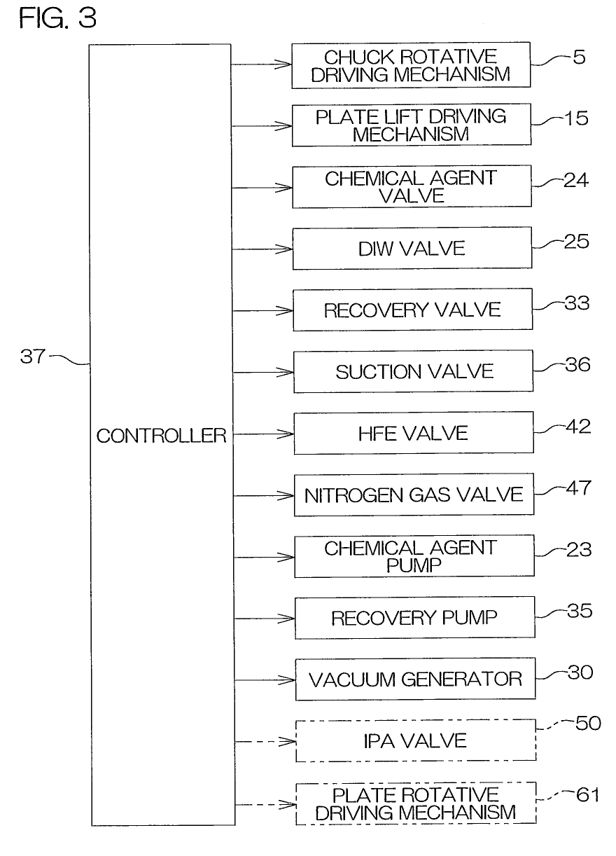

FIG. 3 is a block diagram for explaining the electrical construction of the substrate treatment apparatus. The substrate treatment apparatus includes a controller 37. The controller 37 controls operations of the chuck rotative driving mechanism 5, the plate lift driving mechanism 15, the chemical agent pump 23, the vacuum generator 30 and the recovery pump 35. The controller 37 further controls the opening and closing of the chemical agent valve 24, the DIW valve 25, the HFE valve 42, the nitrogen gas valve 47, the recovery valve 33 and the suction valve 36.

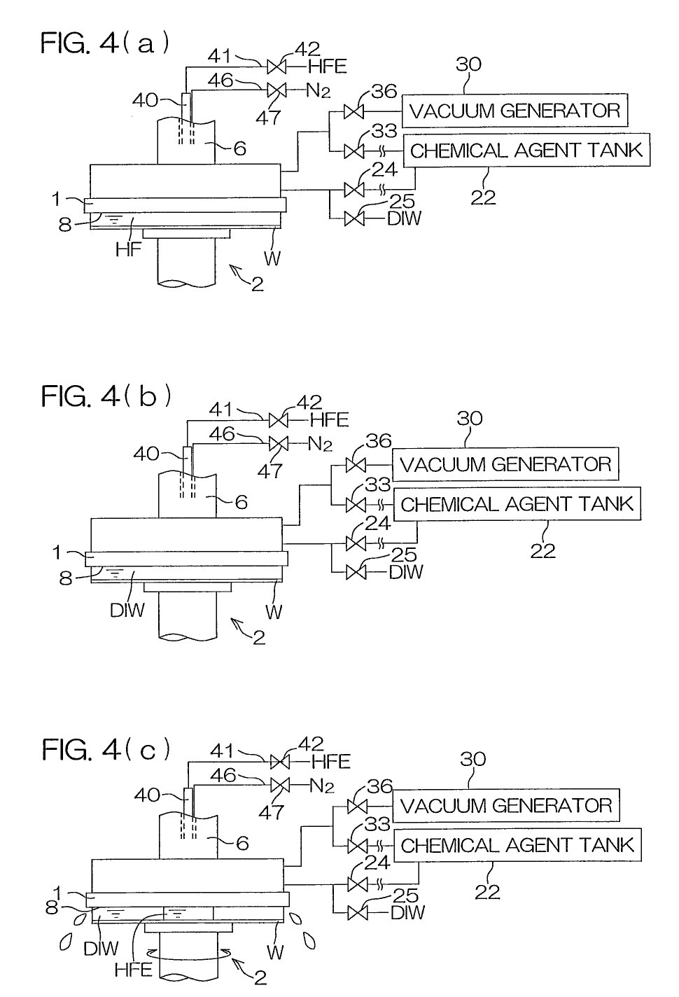

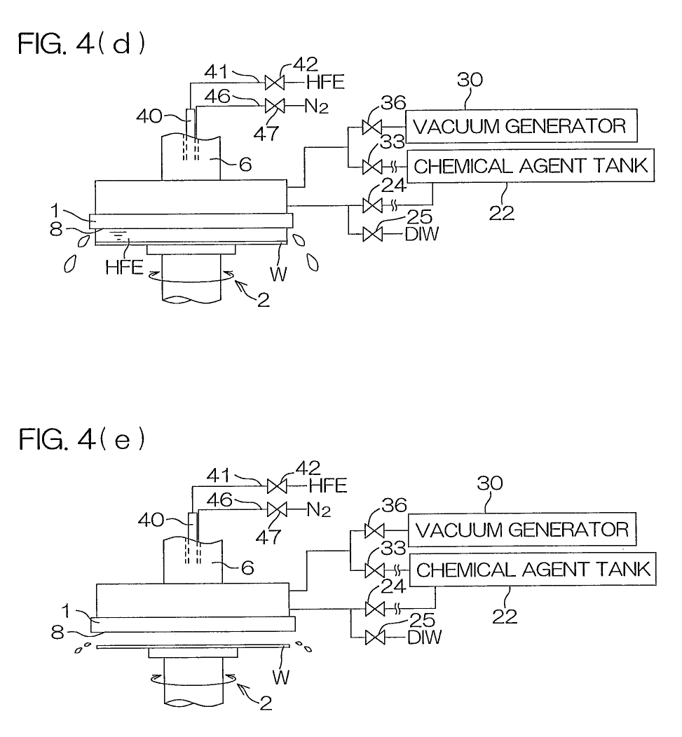

FIGS. 4(a) to 4(e) are diagrams for explaining an exemplary substrate treatment process to be performed by the substrate treatment apparatus.

A substrate W to be treated is loaded into the substrate treatment apparatus by a transport robot not shown, and transferred from the transport robot onto the vacuum chuck 2 with its device formation surface (front surface) up. At this time, the controller 37 controls the plate lift driving mechanism 15 to locate the plate 1 at the retracted position at which the plate 1 is significantly spaced upward from the vacuum chuck 2.

After the substrate W is transferred onto the vacuum chuck 2, the vacuum chuck 2 sucks the rear surface of the substrate W by vacuum to hold the substrate W on the suction base 4 with the front surface of the substrate W upward.

Then, the controller 37 controls the plate lift driving mechanism 15 to move the plate 1 downward to locate the opposed surface 8 in proximity to the front surface of the substrate W. In turn, the controller 37 drives the chemical agent pump 23 with the DIW valve 25, the HFE valve 42 and the nitrogen gas valve 47 being closed and with the chemical agent valve 24 being open, whereby the hydrofluoric acid contained in the chemical agent tank 22 is supplied to the outlet ports 9 through the central supply pipe 16, the supply pipe branches 17 and the supply paths 11 and discharged from the outlet ports 9 toward the front surface of the substrate W. At the same time, the controller 37 drives the recovery pump 35 with the suction valve 36 being closed and with the recovery valve 33 being open, whereby the hydrofluoric acid discharged from the outlet ports 9 is sucked from the suction ports 10. At this time, the substrate W may be rotated or not rotated.

Thus, currents are generated in the hydrofluoric acid supplied to the front surface of the substrate W in such a manner as described with reference to FIG. 2. At the same time, the space defined between the front surface of the substrate W and the opposed surface 8 of the plate 1 is filled with the hydrofluoric acid as shown in FIG. 4(a). That is, the hydrofluoric acid, which is just discharged from the outlet ports 9 and hence has a higher treatment ability, is continuously evenly supplied to the front surface of the substrate W. Thus, the front surface of the substrate W is evenly and efficiently treated with the hydrofluoric acid. Further, the hydrofluoric acid discharged from the outlet ports 9 is sucked from the suction ports 10. Thus, the hydrofluoric acid is reliably recovered in the chemical agent tank 22 through the suction paths 12, the suction pipe branches 29, the central suction pipe 28 and the chemical agent recovery pipe 31 without scattering around the substrate W.

After the hydrofluoric acid is supplied for a predetermined treatment period (e.g., 30 to 60 seconds), the controller 37 closes the chemical agent valve 24 to stop the supply of the hydrofluoric acid to the substrate W, closes the recovery valve 33, and stops the recovery pump 35. Thereafter, the controller 37 opens the DIW valve 25 to supply the DIW to the respective outlet ports 9 and discharge the DIW from the outlet ports 9 toward the front surface of the substrate W. At the same time, the controller 37 opens the suction valve 36 and drives the vacuum generator 30, whereby the DIW discharged from the outlet ports 9 is sucked from the suction ports 10. At this time, the substrate W may be rotated or not rotated.

Thus, the space defined between the front surface of the substrate W and the opposed surface 8 is filled with the DIW, and currents are generated in the DIW present in the space in the aforesaid manner, whereby the DIW is evenly supplied to the front surface of the substrate W as shown in FIG. 4(b). Then, hydrofluoric acid adhering to the front surface of the substrate W is efficiently washed away by the DIW. The DIW discharged from the outlet ports 9 is sucked from the suction ports 10, and drained through the vacuum generator 30 into a drainage system not shown without scattering around the substrate W.

After the DIW is supplied for a predetermined water rinsing period (e.g., 60 seconds), the controller 37 closes the DIW valve 25 to stop the supply of the DIW to the substrate W, closes the suction valve 36 and stops the vacuum generator 30. At the same time, the controller 37 opens the HFE valve 42 to discharge the HFE from the HFE outlet port 44 of the center axis nozzle 40 toward the center portion of the front surface of the substrate W, and controls the chuck rotative driving mechanism 5 to rotate the substrate W held by the vacuum chuck 2 at a predetermined rotation speed (e.g., 100 to 3000 rpm).

Thus, the HFE is supplied to the center portion of the front surface of the substrate W with the space between the front surface of the substrate W and the opposed surface 8 being filled with the DIW as shown in FIG. 4(c). The HFE supplied to the center portion of the front surface of the substrate W receives a centrifugal force generated by the rotation of the substrate W to spread from the center portion to the peripheral edge of the wafer W, whereby the DIW present between the front surface of the substrate W and the opposed surface 8 is squeezed out around the substrate W. That is, the DIW present between the front surface of the substrate W and the opposed surface 8 is replaced with the HFE with the space between the front surface of the substrate W and the opposed surface 8 kept in a liquid sealed state. Then, the space between the front surface of the substrate W and the opposed surface 8 is filled with the HFE as shown in FIG. 4 (d). This suppresses admission of the oxygen-containing atmosphere in the space between the front surface of the substrate W and the opposed surface 8 during a period from the supply of the DIW to the substrate W to the supply of the HFE. Further, the HFE, which is an organic solvent insoluble in the deionized water, completely squeezes out the DIW present between the front surface of the substrate W and the opposed surface 8.

After the HFE is supplied for a predetermined replacement period (e.g., 60 seconds), the controller 37 closes the HFE valve 42 to stop the supply of the HFE to the substrate W, and opens the nitrogen gas valve 47 to supply nitrogen gas from the nitrogen gas outlet port 48 toward the center portion of the front surface of the substrate W. Then, the controller 37 controls the chuck rotative driving mechanism 5 to rotate the substrate W held by the vacuum chuck 2 at a predetermined high rotation speed (e.g., 3000 rpm).

Thus, the HFE present between the front surface of the substrate W and the opposed surface 8 receives a centrifugal force generated by the rotation of the substrate W to be thereby spun off around the substrate W with the front surface of the substrate W kept in a nitrogen gas atmosphere as shown in FIG. 4(e). Then, HFE still remaining on the front surface of the substrate W evaporates by its volatility. Thus, the front surface of the substrate W is dried. Since the DIW supplied to the front surface of the substrate W is completely replaced with the HFE in the aforementioned replacement process, the substrate W is speedily dried as compared with a case in which the replacement process is not performed. Further, the front surface of the substrate W is kept in the nitrogen gas atmosphere, so that improper drying such as formation of water marks on the front surface of the substrate W is suppressed.

After the substrate W is rotated at the high speed for a predetermined spin drying period (e.g., 60 seconds), the controller 37 closes the nitrogen gas valve 47 to stop the supply of the nitrogen gas to the substrate W, and controls the chuck rotative driving mechanism 5 to stop the rotation of the substrate W. Thereafter, the controller 37 controls the plate lift driving mechanism 15 to move up the plate 1. Then, the treated substrate W is unloaded from the vacuum chuck 2 by the transport robot not shown.

According to the embodiment described above, the treatment liquid (hydrofluoric acid or DIW in this embodiment) is discharged from the plurality of outlet ports 9 provided in the opposed surface 8 toward the front surface of the substrate W, and the discharged treatment liquid is sucked from the plurality of suction ports 10 provided in the opposed surface 8 with the plate 1 positioned in closely opposed relation to the front surface of the substrate W. Therefore, while the space between the front surface of the substrate W and the opposed surface 8 is filled with the treatment liquid, currents are generated in the treatment liquid present in the space. Thus, the treatment liquid is evenly supplied to the front surface of the substrate W, so that the front surface of the substrate W is evenly treated with the treatment liquid.

After the water rinsing process is performed by employing the DIW, the HFE is supplied to the front surface of the substrate W with the space between the front surface of the substrate W and the opposed surface 8 sealed with the DIW. Thus, the DIW is replaced with the HFE with the space between the front surface of the substrate W and the opposed surface 8 kept in the liquid sealed state. Thus, the admission of the oxygen-containing atmosphere in the space between the front surface of the substrate W and the opposed surface 8 is suppressed during the period from the supply of the DIW to the substrate W to the supply of the HFE. This suppresses the reactions of the DIW and silicon contained in the front surface of the substrate W with oxygen in the atmosphere, thereby suppressing the formation of water marks.

Further, the HFE which is more volatile than the deionized water and insoluble in the deionized water is employed as the drying promoting fluid, so that the DIW present between the front surface of the substrate W and the opposed surface 8 can be completely replaced with the HFE. Thus, the substrate W is speedily dried.

While the embodiment of the present invention has been described, the invention may be embodied in other ways.

In the embodiment described above, the liquid HFE is supplied as the drying promoting fluid to the front surface of the substrate W by way of example, but the drying promoting fluid may be a liquid containing liquid HFE, a gas containing gaseous HFE (vapor), or a fluid mixture containing liquid HFE and gaseous HFE (vapor). Further, the drying promoting fluid may be a fluid containing an organic solvent, such as methanol, ethanol, acetone, IPA (isopropyl alcohol) or MED (methyl ethyl ketone), which is more volatile than the deionized water and soluble in the deionized water, or a fluid containing an organic solvent, such as HFE, which is more volatile than the deionized water and insoluble in the deionized water.

In the exemplary substrate treatment process described above, the spin-drying process is performed to dry the substrate W, by way of example, by rotating the substrate W at the predetermined high rotation speed after the supply of the HFE to the substrate W. Where a gas (e.g., IPA vapor) is used as the drying promoting fluid, the spin-drying process may be performed or not performed. Where the spin-drying process is not performed, the substrate W is dried by evaporating a very small amount of liquid containing the drying promoting fluid on the front surface of the substrate W after the drying promoting fluid is supplied to the substrate W.

In the exemplary substrate treatment process described above, only the HFE is supplied as the drying promoting fluid to the front surface of the substrate W by way of example, but plural types of drying promoting fluids may be sequentially supplied to the front surface of the substrate W. For example, liquid IPA may be supplied to the front surface of the substrate W after the water rinsing process employing the DIW, and the HFE may be supplied to the front surface of the substrate W after the supply of the IPA.

More specifically, after the water rinsing process employing the DIW, the IPA is supplied from the center axis nozzle 40 to the center portion of the front surface of the rotating substrate W with the space between the front surface of the substrate W and the opposed surface 8 kept sealed with the DIW, and the DIW present between the front surface of the substrate W and the opposed surface 8 is replaced with the IPA. After the supply of the IPA is stopped, the HFE is supplied from the center axis nozzle 40 to the center portion of the front surface of the rotating substrate W, and the IPA present between the front surface of the substrate W and the opposed surface 8 is replaced with the HFE. In this case, the amount of DIW remaining on the front surface of the substrate W is assuredly reduced by replacing the DIW stepwise with the IPA soluble in the deionized water and with the HFE.

The supply of the IPA to the front surface of the substrate W is achieved simply by providing an IPA supply pipe 49 for supplying the IPA to the center axis nozzle 40 and controlling an IPA valve 50 provided in the IPA supply pipe 49 by the controller 37 to open and close the IPA supply pipe 49 (see FIGS. 1 and 3).

In the embodiment described above, the HFE is supplied from the center axis nozzle 40 inserted through the support shaft 6 to the front surface of the substrate W by way of example. Alternatively, an HFE nozzle for supplying the HFE to the front surface of the substrate W may be provided adjacent the periphery of the substrate W, so that the DIW present between the front surface of the substrate W and the opposed surface 8 is replaced with the HFE by supplying the HFE from a peripheral side of the substrate W onto the front surface of the substrate W.

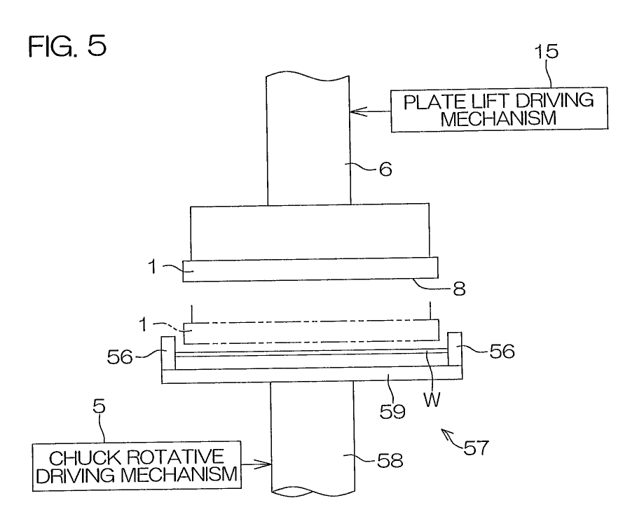

In the embodiment described above, the vacuum chuck 2 is employed as the substrate holding unit by way of example. Alternatively, a mechanical spin chuck 57 may be employed as the substrate holding unit, which is adapted to hold the substrate W by holding a peripheral surface of the substrate W by a plurality of holding members 56 thereof as shown in FIG. 5.

More specifically, the spin chuck 57 includes a rotation shaft 58 extending generally vertically, and a disk-shaped spin base 59 attached to an upper end of the rotation shaft 58. The holding members 56 are disposed circumferentially of the spin base 59 in association with the outer periphery of the substrate W. The holding members 56 are brought into abutment against the peripheral surface of the substrate W at different positions to cooperatively hold the substrate W generally horizontally.

Where the mechanical spin chuck 57 is employed as the substrate holding unit, the plate 1 is preferably dimensioned such as to have a smaller outer diameter than the substrate W and cover at least the entire device formation region of the substrate W (a front surface portion of the substrate W excluding a peripheral edge portion of the substrate W) for prevention of interference between the plate 1 and the holding members 56.

In the embodiment described above, the plate 1 and the support shaft 6 are not rotated, but the support shaft 6 may be coupled to a plate rotative driving mechanism 61 (see FIG. 1), so that the support shaft 6 and the plate 1 can be rotated generally coaxially with the center axis of the chuck shaft 3 by controlling the plate rotative driving mechanism 61 by the controller 37 (see FIG. 3). Thus, the hydrofluoric acid and the DIW can be evenly supplied to the front surface of the substrate W by discharging the hydrofluoric acid or the DIW from the outlet ports 9 while rotating the plate 1 by the plate rotative driving mechanism 61.

Where the substrate W is rotated by the substrate holding unit and, at the same time, the plate 1 is rotated, the rotation direction of the plate 1 may be the same as or opposite to the rotation direction of the substrate W.

In the embodiment described above, the plate 1 has a disk shape having a greater diameter than the substrate W by way example, but may be smaller than the substrate W. In this case, a plate moving mechanism for moving the plate 1 may be provided, so that the hydrofluoric acid or other liquid or gas can be evenly supplied to the entire front surface of the substrate W by moving (scanning) the opposed surface 8 of the plate 1 within a horizontal plane above the substrate W by the plate moving mechanism.

In the embodiment described above, the hydrofluoric acid is employed as the chemical agent to be supplied to the front surface of the substrate W by way of example, but the chemical agent is not limited to the hydrofluoric acid. Any other chemical agent such as an etching liquid, a polymer removing agent or a resist removing agent may be supplied to the front surface of the substrate W.

In the embodiment described above, the nitrogen gas is employed as the inert gas to be supplied to the front surface of the substrate W by way of example, but the inert gas is not limited to the nitrogen gas. Any other inert gas such as helium gas, argon gas or dry air may be supplied to the front surface of the substrate W.

In the embodiment described above, the DIW is employed as the rinse liquid to be supplied to the front surface of the substrate W by way of example, but the rinse liquid is not limited to the DIW. Any other rinse liquid such as carbonated water, electrolyzed ion water, hydrogen water, magnetic water or like functional water, or ammonia water having a very low concentration (e.g., about 1 ppm) may be supplied to the front surface of the substrate W.

In the embodiment described above, the semiconductor wafer is employed as the substrate W to be treated, but the substrate W to be treated is not limited to the semiconductor wafer. Other examples of the substrate to be treated include substrates for liquid crystal display devices, substrates for plasma display devices, substrates for FED devices, substrates for optical disks, substrates for magnetic disks, substrates for magneto-optical disks, substrates for photo masks, and the like.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2006-254913 filed in the Japanese Patent Office on Sep. 20, 2006, the disclosure of which is incorporated herein by reference.

What is claimed is:

1. A substrate treatment apparatus comprising:
a plate to be positioned in spaced opposed relation to one surface of a substrate and having a plurality of outlet ports and a plurality of suction ports provided in an opposed surface thereof to be opposed to the one surface of the substrate;
a rinse liquid supplying unit which supplies a rinse liquid containing deionized water to the outlet ports of the plate;
a suction unit which evacuates the suction ports of the plate;
a drying promoting fluid supplying unit which supplies a drying promoting fluid to the one surface of the substrate to promote drying of the substrate;
a substrate holding unit to be positioned on the other surface of the substrate opposite from the one surface for holding the substrate; and
a supply controlling unit which controls the rinse liquid supplying unit to discharge the rinse liquid from the outlet ports toward the one surface of the substrate to seal a space defined between the one surface and the opposed surface with the rinse liquid, and controls the drying promoting fluid supplying unit to supply the drying promoting fluid to the one surface with the space between the one surface and the opposed surface kept in a liquid sealed state to replace the rinse liquid present between the one surface and the opposed surface with the drying promoting fluid.

2. A substrate treatment apparatus as set forth in claim 1, wherein the drying promoting fluid supplying unit supplies a liquid containing an organic solvent more volatile than the deionized water as the drying promoting fluid to the one surface.

3. A substrate treatment apparatus as set forth in claim 1, wherein the drying promoting fluid supplying unit supplies a vapor containing an organic solvent more volatile than the deionized water as the drying promoting fluid to the one surface.

4. A substrate treatment apparatus as set forth in claim 1, wherein the drying promoting fluid supplying unit supplies the drying promoting fluid to the one surface of the substrate from a drying promoting fluid outlet port which is provided in the opposed surface of the plate to be brought into opposed relation to a center of the one surface.

5. A substrate treatment apparatus as set forth in claim 1, further comprising a substrate rotating unit which rotates the substrate held by the substrate holding unit about an axis intersecting the one surface.

6. A substrate treatment apparatus as set forth in claim 5, further comprising a plate rotating unit which rotates the plate generally coaxially with the axis.

7. A substrate treatment method comprising the steps of:
supplying a rinse liquid containing deionized water to one surface of a substrate from a plurality of outlet ports provided in an opposed surface of a plate positioned in spaced opposed relation to the one surface, and sucking the rinse liquid discharged from the outlet ports from a plurality of suction ports provided in the opposed surface of the plate to seal a space defined between the one surface and the opposed surface with the rinse liquid; and
supplying a drying promoting fluid to the one surface of the substrate with the space between the one surface and the opposed surface sealed with the rinse liquid to replace the rinse liquid present between the one surface and the opposed surface with the drying promoting fluid.
